(19) United States
(12) Patent Application Publication
(10) Pub. No.: US 2011/0139190 A1
(43) Pub. Date: Jun. 16, 2011

(54) Apparatus, method and system for substantially preventing mold in front loading washing machines

(76) Inventor: Marlan L. Northrup, Albuquerque, NM (US)

(21) Appl. No.: 12/653,430

(22) Filed: Dec. 14, 2009

(51) Int. Cl. B08B 5/00; D06F 39/00

(52) U.S. Cl. 134/34; 68/235 R

(57) ABSTRACT

The present invention is generally directed to providing an apparatus, method or system for substantially or completely removing mold (and thus, odor) from a front loading washing machine. Briefly, the present invention may be described as a gasket air tee and may be further generally described as a venting apparatus or device having an elongated main portion and an elongated handle portion, the main portion being attached or otherwise integrated with the handle portion, the main portion further being in air flow communication with the handle portion. This apparatus may be used in a method or system for substantially preventing mold typically found within a gasket assembly in a front loading washing machine.

### FIELD OF INVENTION

The present invention relates generally to an apparatus, method and system for removing or substantially removing mold which may arise in a front loading washing machine.

### BACKGROUND OF THE INVENTION

Front loading washing machines have been a staple of European homes for decades. Front loading washing machines are advertised as being more energy and water efficient, and more gentle on clothing. Only recently has the fad of owning and using a front loading washing machine hit the United States and other parts of the world.

Conventional top-loading washing machines wash clothes by using a large agitator to force clothes back and forth through soapy water, and then again through clean water to rinse out detergent. These machines are also known as vertical-axis washers, because the tub spins vertically. In contrast, front load washers work in an entirely different way. The front load washing machines spin horizontally, and are sometimes called horizontal-axis washers. There is no agitator to move the clothes through the water, but rather, the interior tub or drum itself moves, causing the clothes to be repeatedly lifted out of the water and plunged back in.

A typical front loading washing machine mounts an inner washer drum and outer tub horizontally. Loading of dirty clothes is done through a door at the front of the machine. The door may sometimes contain a clear window. Agitation is supplied by the back-and-forth rotation of the cylinder and by gravity. The clothes are lifted up by paddles on the inside wall of the drum and then dropped. This motion flexes the weave of the fabric and forces water and detergent solution through the clothing material. Because the wash action does not require the clothing be freely suspended in water, only enough water is needed to moisten the fabric. Because less water is required, front-loaders typically use less soap, because the aggressive dropping and folding action of the tumbling can easily produce large amounts of foam or suds.

Front loading washers are mechanically simple compared to top-loaders, with the main motor normally being connected to the drum via a grooved pulley belt and large pulley wheel, without the need for a gearbox, clutch or crank. But front-load washers suffer from their own technical problems, due to the drum lying sideways. For example, a top loading washer keeps water inside the tub merely through the force of gravity pulling down on the water, while a front-loader must tightly seal the door shut with a door means for sealing (e.g., a gasket assembly) to prevent dripping water onto the floor during the wash cycle. The gasket assembly, typically formed primarily of rubber or like pliable material (such as, for example, resin), is usually form installed at an approximate periphery of the opening or inlet to the tub so as to seal a gap between the opening and the front loading washing machine's tub. Moreover, the access door must remain locked shut during the entire wash cycle, since opening the door with the machine in use will result in water gushing out onto the floor.

Nearly all front-loader washers for the consumer market must also use a folded flexible bellows assembly around the door opening, to keep clothing contained inside the basket during the tumbling wash cycle. If this bellows assembly were not used, small articles of clothing such as socks could slip out of the wash basket near the door, and fall down the narrow slot between the outer tub and basket, plugging the drain and possibly jamming rotation of the inner basket. Retrieving lost items from between the outer tub and inner basket can require complete disassembly of the front of the washer and pulling out the entire inner wash basket. Commercial and industrial front-loaders used by businesses usually do not use the bellows, and instead require all small objects to be placed in a mesh bag to prevent loss near the basket opening.

The gasket assembly around the front loading washing machine's front door is a major source of problems for a front loading washing machine. A typical rubber gasket is inserted into a channel periphery in the front opening of the washing machine. In some configurations, this gasket typically has a large number of flexible folds to permit the tub to move separately from the door during the high speed extraction cycle. Such folds can collect lint, dirt, and moisture (and the occasional lost small clothing item), resulting in mold, fungus and/or mildew growth (collectively and/or individually referred to as “mold” for brevity purposes) around the gasket, slime on or underneath the gasket, a blackish film on the gasket and/or a foul odor being emitted from the machine and transferred to clothes during the washing process. In other configurations, the gasket assembly appears as a smooth rubber gasket to a casual observer. In still other configurations, some manufacturers have inserted one or more holes in the gasket in an attempt to help evaporation of detergent and/or rinse water from the machine. Even if new, the gasket may not prevent the proper drainage of cleaning liquid within the washing machine, so that some of the cleaning liquid remains in various areas of the channel adjacent to the gasket. This problematic area is usually found on or adjacent to the rubber boot and in or around the metal rim periphery where the boot and rim are adjacent to one another, and is usually more prominent near the bottom portion of the metal rim (where the cleaning liquid will pool). This pooled water remaining has the high probability of becoming polluted as time elapses, thereby generating mold and/or odor, which is both unpleasant and also unsanitary. U.S. Patent Publication US 2009/0064422 A1 attributes the mold problem to arise from metal soap build-up, which may propagate microorganisms, thereby leading to mold and rot. The build-up of mold in these situations have reported to be a major cause of significant or chronic health problems, as well. Moreover, clothes or other items laundered in moldy environments usually cannot be further used, because of the odor problem.

Some front-loading washer operating instructions say the gasket and surrounding channels should be wiped down monthly with a strong bleach solution, while others offer a special freshening cycle where the machine is run empty with a strong dosing of bleach. In the past, suggested mold-preventative remedies have also included adding vinegar, chlorine, mouth wash, baking soda or similar cleaning products to the laundry detergent, running an empty cycle with bleach every few weeks, wiping the door gasket with a diluted bleach solution every other week, using the hottest water setting available, using the “correct” high efficiency (HE) detergent available, and leaving the front-loading washer door ajar between loads to assist in water evaporation.

The front door of a front loading washing machine (sometimes referred to as “front loaders) have to seal completely or the water within the tub will leak out (unlike top loading washing machines). This means that the interior portion(s) of the front loaders will stay damp even after the door is closed. Manufacturers recommend to leave the front door ajar for a period after the last washing load is done to help dry out the tub's interior. Some newer front loaders are designed to spray jet water around the gasket assembly seal and under the seal to clean and sanitize it thoroughly. Some manufacturers have also installed drainage holes underneath the rubber gasket or even in the gasket itself, so that the water would drain and not remain under the rubber gasket. Some other manufacturers have installed an “antimicrobial agent” impregnated into the rubber gasket in an attempt to stop the mold problem. Unfortunately, even after attempting all of these methods, in many instances, the mold remains and continues to present an odor problem in clothes and in the front loading washing machine itself. Indeed, since as early as 2007, there have been numerous class-action litigation cases which were filed against front loading washing machine manufacturers concerning the mold problem. And, it goes without saying that consumers who use front loading washing machines likely have spent significant amounts of money replacing clothing, cloths and/or towels (or the like) which contain the moldy smell.

Some prior art disclosures show use of other built-in devices which is designed to prevent mold. Thus for example, U.S. Patent Publication US 2009/0126418 A1 discloses a drum type washing machine that includes a concave drain. This disclosure also advises that the drain portion be coated with an antibiotic material such as lactic-acid of fermented kimchi to prevent the mold problem. This disclosure also discusses the use of a heating member in the lower portion of the gasket assembly in order to further assist in evaporating any remaining water.

What is needed is an apparatus, system or method which substantially reduces or even eliminates the mold problem typically found within a gasket assembly in a front loading washing machine. This apparatus, preferably, for example, should be easy to use in any front loading washing machine, reusable, recyclable, washable, retrievable and durable.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

The present invention comprises generally, an apparatus, system or method which is adapted to substantially or completely eliminate mold, mildew and/or any unwanted fungus that resides and/or builds up in front loader washing machines. The present invention is generally directed to providing an apparatus, method or system for substantially or completely removing mold (and thus, odor) from a front loading washing machine. Briefly, the present invention may be generally described as a venting apparatus or device having an elongated main portion and an elongated handle portion, the main portion being attached or otherwise integrated with the handle portion, the main portion further being in air flow communication with the handle portion. This apparatus may be used in a method or system for substantially preventing mold typically found within a gasket assembly in a front loading washing machine.

This disclosure describes numerous specific details that include specific structures and elements, their particular arrangement, and their particular functions in order to provide a thorough understanding of the present invention. One skilled in the art will appreciate that one may practice the present invention without the specific details.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The accompanying figures further illustrate the present invention and, together with the detailed description of the preferred embodiment, assists to explain the general principles according to the present invention.

FIG. 1a represents one exemplary embodiment of the present invention, illustrating a front side view of the present invention, the other side view being a mirror image;

FIG. 1b illustrates a top view of the invention depicted in FIG. 1a;

FIG. 1c illustrating a left side view of the invention depicted in FIG. 1a, the other side view being a mirror image;

FIG. 1d illustrates an exemplary view of the elongated main portion of the invention depicted in FIG. 1a;

FIG. 1e illustrates a bottom side perspective view of the invention depicted in FIG. 1a;

FIG. 1f illustrates a top side perspective view of the invention depicted in FIG. 1a;

FIG. 1g illustrates the invention as depicted in FIGS. 1a-1f as may be insertable into a front loading washing machine, the illustration showing a plurality of devices variously interspersed underneath a front loading washing machine's rubber gasket assembly area,

FIG. 2a represents another exemplary embodiment of the present invention, illustrating a side view of the present invention, the other side view being a mirror image;

FIG. 2b illustrates a top view of the invention depicted in FIG. 2a;

FIG. 2c illustrating a left side view of the invention depicted in FIG. 2a, the other side view being a mirror image;

FIG. 2d illustrates a bottom side perspective view of the invention depicted in FIG. 2a;

FIG. 2e illustrates a bottom side perspective view of the invention depicted in FIG. 2a; and

FIG. 2f illustrates the invention as depicted in FIGS. 2a-2e as may be insertable into a front loading washing machine, the illustration showing a plurality of devices variously interspersed within a front loading washing machine's rubber gasket assembly area.

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

The present invention is a apparatus, system or method which is adapted for insertion into and removal from a rubber gasket assembly conventionally installed within a front loading washing machine, and which does not require any modification to existing front loading washing machines.

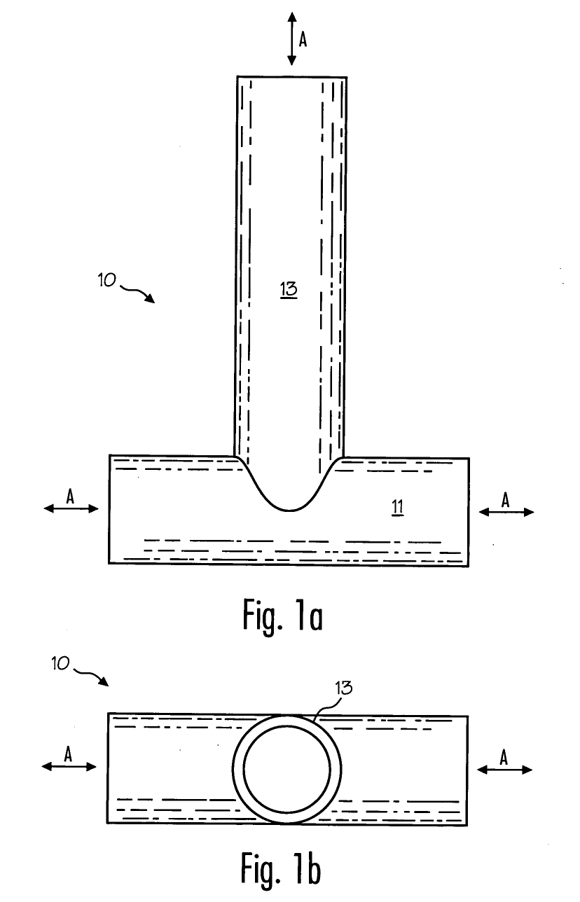

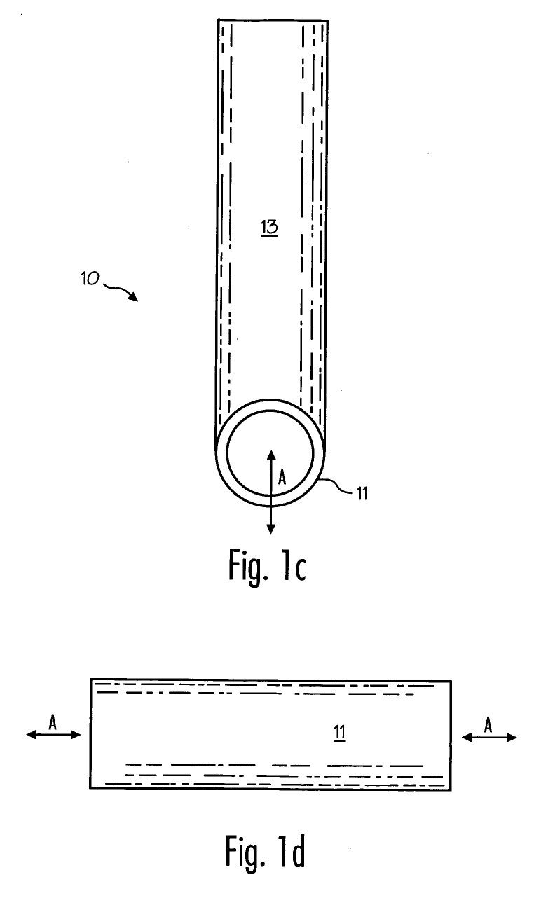

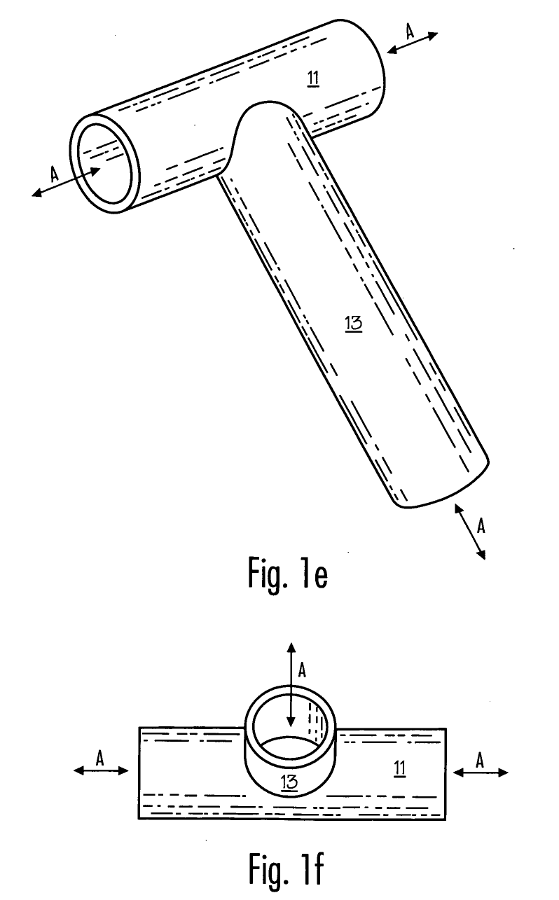

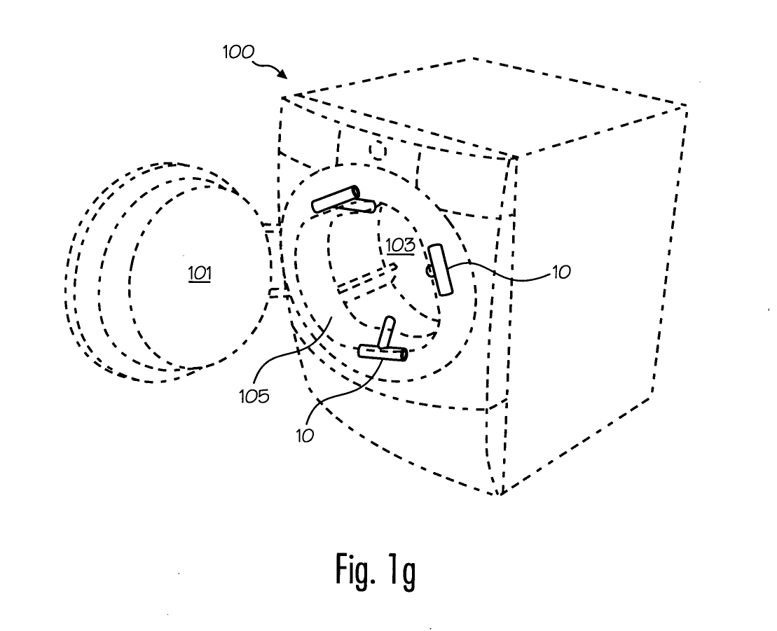

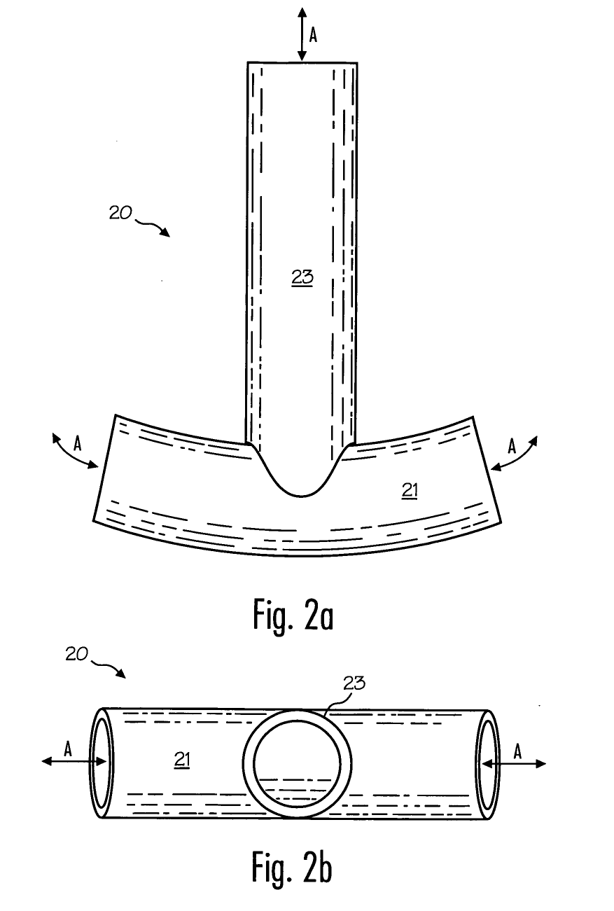

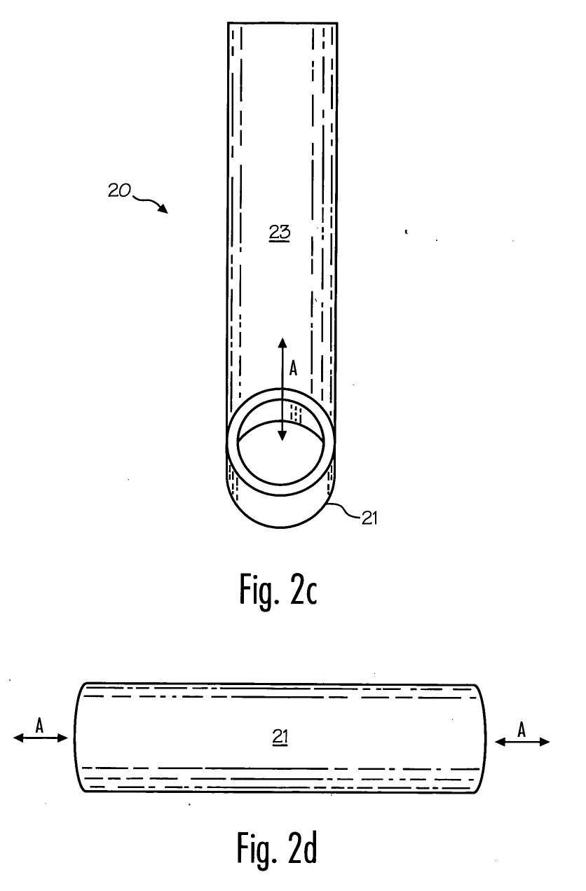

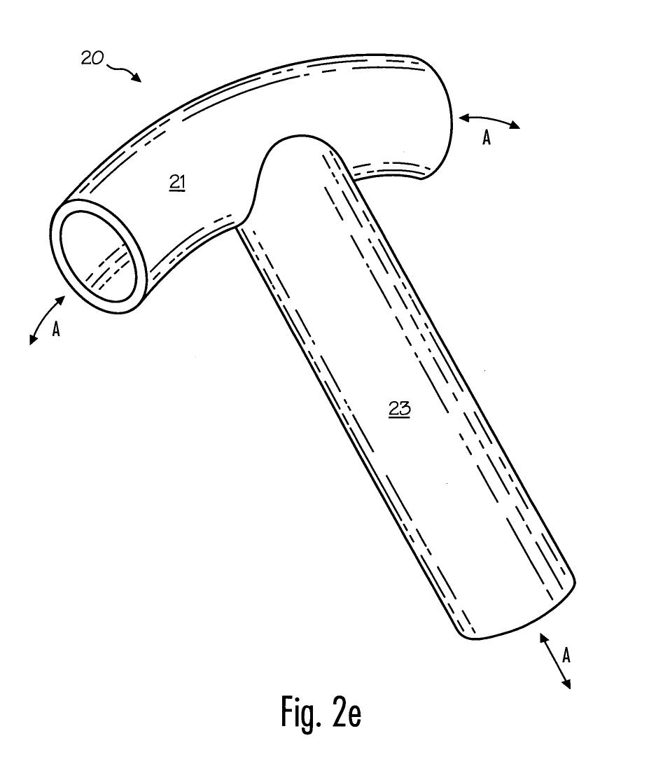

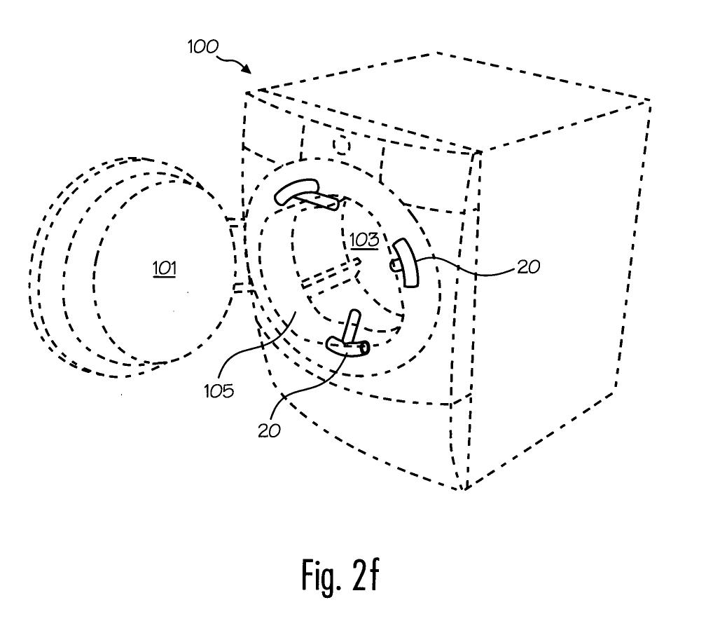

An exemplary front loading washing machine 100 is shown in FIGS. 1g and 2g. In these illustrations, a front loading washing machine 100 is shown, having a front door 101 and an interior tub area 103. The front loading washing machine's gasket assembly 103 is depicted, the gasket assembly 103 being typically installed at an approximate periphery of the opening or inlet to the tub 103 so as to seal a gap between the opening and the front loading washing machine's tub when the front door 101 is closed.

As seen in FIGS. 1a-1f, the present invention is generally described as a venting apparatus or device 10 having an elongated main portion 11 and an elongated handle portion 13, the main portion 11 being coupled to or otherwise integrated with the handle portion 13. In the embodiments shown, the present invention 10 is generally “T” shaped, which is useful for handling while either inserted or removing the invention from a front loading washing machine's gasket assembly 105. However, those of skill in the art will recognize that other shapes and configurations are available even if not illustrated, and thus, the basic shape could be described as “L” shaped (for example, wherein one end of the main portion 11 is attached to another end of the handle portion 13).

As shown in FIGS. 1a-1g, both the main portion 11 and the handle portion 13 are preferably both hollow, so that the main portion 11 hollow pathway is in air flow communication with the handle portion 13 hollow pathway (in the drawings provided, the line representation labeled as “A” depicting exemplary air flow through the hollow pathways). Those of skill in the art will realize that in this configuration, the additional air flow or air movement from underneath the gasket assembly, when combined with the air flow or air movement occurring through the hollow pathways of the main portion 11 and the handle portion 13, will further enhance the invention's ability to allow substantial or complete venting, drying or evaporation of any pooled water when the front door is allowed to be left ajar or open for a predetermined period of time. This type of configuration has been highly successful in substantially or completely eliminating mold in prototypes when built and tested. More specifically, a prototype formed of polyvinyl chloride (commonly referred to as “PVC” material) was built and tested, and performed in accordance with expectations to substantially reduce or eliminate mold. Of course, those of skill in the art will recognize that either the main portion 11 or the handle portion 13 may separately be hollow, but in this embodiment, it is believed that the air flow to effectuate a reduction of mold or mold growth in the gasket assembly 105 may be lessened. Also, the present invention contemplates injecting either the main portion 11 or the handle portion 13 with one or more suitable antimicrobial agents (which definition may include antibiotics) which are adapted to reduce or eliminate mold. In this regard, the term “injecting” not only means introducing or otherwise mixing a suitable antimicrobial agent into the material used to form either the main portion 11 or the handle portion 13, but also refers to coating the main portion 11 or the handle portion 13 with a suitable antimicrobial agent.

As seen in FIG. 1g, in use the present invention is preferably adapted to be insertable into or otherwise introduced into, and removable from, an underneath portion of the front loading washing machine's gasket assembly 105. More preferably, the main portion 11 is adapted for positioning to fit substantially underneath the gasket assembly 105, the handle portion having a section which fits underneath the gasket assembly and being adapted to jut out and away from the gasket assembly (preferably in a direction towards the washing machine's tub 103). In a preferred embodiment, at least one apparatus is positioned underneath the gasket assembly 105 in an area adjacent to the suspected pooled water area. In another preferred embodiment, a system of at least three apparatus are variously interspersed substantially underneath the gasket assembly 105.

As will be appreciated by one of ordinary skill in the art, the present invention may be embodied as a system, process or apparatus, or any combination thereof. Additionally, in the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Another embodiment of the present invention is shown in FIGS. 2a-2f. In this embodiment, the present invention is generally described as a venting apparatus or device 20 having a curved elongated main portion 21 and an elongated handle portion 23, the main portion 21 being attached or otherwise integrated with the handle portion 23. Preferably, the angle of curvature of the curved elongated main portion 21 is substantially the same as the curvature of the gasket assembly's 103 periphery, so that the angle substantially registers with the curvature of the gasket assembly's periphery. In the embodiments shown, the present invention 20 is generally “T” shaped, which is useful for handling while either inserted or removing the invention from a front loading washing machine's gasket assembly 105. However, those of skill in the art will recognize that other shapes and configurations are available even if not illustrated, and thus, the basic shape could be described as “L” shaped (for example, wherein one end of the main portion 21 is attached to another end of the handle portion 23).

As shown in FIGS. 2a-2g, both the main portion 21 and the handle portion 23 are preferably both hollow, so that the main portion 21 hollow pathway is in air flow communication with the handle portion 23 hollow pathway (in the drawings provided, the line representation labeled as “A” depicting exemplary air flow through the hollow pathways). Those of skill in the art will realize that in this configuration, the additional air flow or air movement from underneath the gasket assembly, when combined with the air flow or air movement occurring through the hollow pathways of the main portion 21 and the handle portion 23, will further enhance the invention's ability to allow substantial or complete venting, drying or evaporation of any pooled water when the front door is left ajar for a predetermined period of time.

As seen in FIG. 2g, the present invention is preferably adapted to be insertable into, and removable from, an underneath portion of the front loading washing machine's gasket assembly 105, In a preferred embodiment, at least one apparatus is positioned underneath the gasket assembly 105 in an area adjacent to the suspected pooled water area. In another preferred embodiment, a system of at least three apparatus are variously interspersed substantially underneath the gasket assembly 105.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

Other variations and modifications of the present invention will be apparent to those of ordinary skill in the art, and it is the intent of the appended claims that such variations and modifications be covered. The particular values and configurations discussed above can be varied, are cited to illustrate representative embodiments of the present invention and are not intended to limit the scope of the invention. It is contemplated that the use of the present invention can involve components having different characteristics as long as the principle is followed.

I claim:

1. An apparatus for substantially removing mold from a front loading washing machine having a front door and a gasket assembly which is approximately installed at a periphery of an opening to the washing machine so as to seal a gap between the front door and a tub within the front loading washing machine, the apparatus comprising an elongated main portion and an elongated handle portion, the main portion being coupled to or otherwise integrated with the handle portion, the main portion adapted for positioning to fit substantially underneath the gasket assembly, the handle portion having a section which fits underneath the gasket assembly and adapted to jut out and away from the gasket assembly.

2. The apparatus of claim 1 wherein the main portion is hollow and the handle portion is hollow, and wherein the main portion being in air flow communication with the handle portion.

3. The apparatus of claim 2 wherein the main portion and the handle portion are formed of polyvinyl chloride (PVC).

4. The apparatus of claim 1 wherein the main portion is hollow.

5. The apparatus of claim 4 wherein the main portion is injected with one or more antimicrobial agents adapted to reduce or eliminate mold.

6. The apparatus of claim 1 wherein the handle portion is hollow.

7. The apparatus of claim 6 wherein the handle portion is injected with one or more antimicrobial agents adapted to reduce or eliminate mold.

8. A method for removing mold from a front loading washing machine having a front door and a gasket assembly which is approximately installed at a periphery of an opening to the washing machine so as to seal a gap between the front door and a tub within the front loading washing machine, the method comprising introducing at least one hollow venting device underneath the gasket assembly and allowing the front door to remain in an open position for a predefined time period in order to substantially or completely eliminate mold.

9. The method of claim 8, the venting device comprising an elongated main portion and an elongated handle portion, the main portion being coupled to or otherwise integrated with the handle portion, the main portion adapted for positioning to fit substantially underneath the gasket assembly, the handle portion having a section which fits underneath the gasket assembly and adapted to jut out and away from the gasket assembly.

10. The method of claim 9 wherein the main portion and the handle portion are formed from polyvinyl chloride (PVC).

11. The method of claim 9 wherein the main portion is hollow.

12. The method of claim 11 wherein the main portion is injected with one or more antimicrobial agents adapted to reduce or eliminate mold.

13. The method of claim 9 wherein the handle portion is hollow.

14. The method of claim 13 wherein the handle portion is injected with one or more antimicrobial agents adapted to reduce or eliminate mold.

15. An air venting device for substantially removing mold from a front loading washing machine having a front door and a gasket assembly that is approximately installed at a periphery of an opening to the washing machine so as to seal a gap between the front door and a tub within the front loading washing machine, the device comprising a hollow elongated main portion and a hollow elongated handle portion, the main portion being coupled to or otherwise integrated with the handle portion, the main portion being in air flow communication with the handle portion, the main portion adapted for positioning to fit substantially underneath the gasket assembly, the handle portion having a section which fits underneath the gasket assembly and adapted to jut out and away from the gasket assembly.

16. The device of claim 15 wherein the main portion is injected with one or more antimicrobial agents adapted to reduce or eliminate mold.

17. The device of claim 15 wherein the handle portion is injected with one or more antimicrobial agents adapted to reduce or eliminate mold.
